(19) United States
(12) Patent Application Publication
(10) Pub. No.: US 2009/0180053 A1
(43) Pub. Date: Jul. 16, 2009

(54) OPTICAL PLATE, DISPLAY DEVICE HAVING THE OPTICAL PLATE, AND METHOD OF MANUFACTURING THE OPTICAL PLATE

(75) Inventors: Min-Young SONG, Seoul (KR); Jin-Sung CHOI, Cheonan-si (KR); Byung-Yun JOO, Seoul (KR); Sang-Hoon LEE, Cheonan-si (KR); Dong-Kwan KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/193,108

(22) Filed: Aug. 18, 2008

(30) Foreign Application Priority Data
Jan. 16, 2008 (KR) 1020080005071

(51) Int. Cl. G02F 1/13357; F21V 5/02; B29D 11/00; G02B 1/04

(52) U.S. Cl. 349/62; 362/330; 264/1.7

(57) ABSTRACT

An optical plate includes a core layer and a surface layer. The surface layer is disposed on at least one surface of the core layer and includes a plurality of prism patterns. The core layer and the surface layer have different glass transition temperatures.

This application claims priority to Korean Patent Application No. 10-2008-0005071 filed on Jan. 16, 2008, and all the benefits accruing therefrom under 35 U.S.C. §119, the disclosure of which is incorporated herein by reference in its entirety.

### BACKGROUND OF THE INVENTION

1. Field of the Invention

The present invention relates to an optical plate, a display device having the optical plate and a method of manufacturing the optical plate, and more particularly, to an optical plate contributing to the stability of dimension and the reduction of manufacturing costs, a display device having the optical plate and a method of manufacturing the optical plate.

2. Description of the Related Art

A liquid crystal display (“LCD”) may include two display panels having a plurality of electrodes, such as pixel electrodes and common electrodes, generating an electric field, and a liquid crystal layer interposed between the two display panels. An LCD controls the polarization of incident light and thus generates images by applying a voltage to a number of electrodes generating an electric field in a liquid crystal layer. When the electric field is applied to the liquid crystal layer, an alignment of liquid crystal molecules in the liquid crystal layer can be controlled and the images are generated.

A backlight assembly includes a light source which generates light, an optical plate which guides light emitted from the light source toward a liquid crystal panel, one or more optical sheets which improve the luminance and uniformity of light emitted from the optical plate toward the liquid crystal panel, and a reflective sheet disposed below the optical plate. A backlight assembly may also include a number of relatively fine prism patterns, which are formed on at least one of the top and the bottom surface of an optical plate, and further improve the luminance and uniformity of light emitted from the optical plate toward a liquid crystal panel. A manufacturing process including heat and/or pressure may be employed to form the prism patterns on the optical plate.

### BRIEF SUMMARY OF THE INVENTION

Since the manufacturing or forming of prism patterns on an optical plate may include heat and/or pressure, the optical plate may be deformed due to the heat and/or pressure. For example, the heat and/or pressure deforming the optical plate may thereby deteriorate the stability of dimension of the optical plate. Furthermore, since the optical plate may be deformed, additional processes may be required to manufacture the optical plate. For example, post-treatment such as cutting may be required to complete the manufacturing of the optical plate, thereby complicating the manufacture of the optical plate and increasing the manufacturing cost of the optical plate.

An exemplary embodiment provides an optical plate which contributes to the stability of dimension of the optical plate during manufacturing and the reduction of manufacturing costs.

An exemplary embodiment provides a display device including an optical plate which contributes to the stability of dimension and the reduction of manufacturing costs.

An exemplary embodiment provides a method of manufacturing an optical plate which contributes to the stability of dimension and the reduction of manufacturing costs.

In an exemplary embodiment, there is provided an optical plate including a core layer, and a surface layer disposed on at least one surface of the core layer. The surface layer includes a plurality of prism patterns. The core layer and the surface layer have different glass transition temperatures.

In an exemplary embodiment, there is provided a display device including a light source generating light, an optical plate guiding light emitted from the light source and including a core layer and a surface layer disposed on at least one surface of the core layer, an optical sheet disposed on the optical plate, and a display panel disposed on the optical sheet and displaying images. The surface layer includes a plurality of prism patterns and has a different glass transition temperature from that of the core layer.

In an exemplary embodiment, there is provided a method of manufacturing an optical plate. The method includes preparing a bare optical plate and forming a plurality of prism patterns on the surface layer including a core layer and a surface layer disposed on at least one surface of the core layer. The surface layer has a different glass transition temperature from that of the core layer

### BRIEF DESCRIPTION OF THE DRAWINGS

The above and other features and advantages of the present invention will become apparent by describing in detail exemplary embodiments thereof with reference to the attached drawings in which:

FIG. 1 illustrates an exploded perspective view of an exemplary embodiment of a liquid crystal display (“LCD”) including a backlight assembly according to the present invention;

FIG. 2 illustrates a cross-sectional view of an exemplary embodiment of the backlight assembly of FIG. 1 according to the present invention;

FIG. 3 illustrates an enlarged perspective view of portion A of FIG. 2;

FIG. 4 illustrates a cross-sectional view of another exemplary embodiment of a backlight assembly according to the present invention;

FIG. 5 illustrates an enlarged perspective view of portion B of FIG. 4;

FIG. 6 illustrates a cross-sectional view of another exemplary embodiment of a backlight assembly according to the present invention;

FIG. 7 illustrates an enlarged perspective view of portion C of FIG. 6;

FIG. 8 illustrates a cross-sectional view of another exemplary embodiment of a backlight assembly according to the present invention;

FIG. 9 illustrates an enlarged perspective view of portion D of FIG. 8;

FIG. 10 illustrates a cross-sectional view of another exemplary embodiment of a backlight assembly according to the present invention;

FIG. 11 illustrates an enlarged perspective view of portion E of FIG. 10;

FIG. 12 illustrates a cross-sectional view of another exemplary embodiment of a backlight assembly according to the present invention;

FIG. 13 illustrates an enlarged perspective view of portion F of FIG. 12;

FIG. 14 illustrates a cross-sectional view for explaining an exemplary embodiment of a method of patterning a bare light guide plate according to the present invention; and

FIG. 15 illustrates a cross-sectional view of an exemplary embodiment of a light guide plate obtained by the method of FIG. 14.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

It will be understood that when an element is referred to as being “connected to” or “disposed on” another element, it can be directly connected to or disposed on the other element or intervening elements may be present. In contrast, when an element is referred to as being “directly connected to” or “directly disposed on” another element, there are no intervening elements present. Like numbers refer to like elements throughout. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

The present invention is hereinafter described in detail, taking a liquid crystal display (“LCD”) as an example of a display device, a liquid crystal panel as an example of a display panel for displaying images, and a light guide plate with an edge-type light source module as an example of an optical plate. However, the present invention is not restricted thereto. That is, the present invention can be applied to nearly all types of display devices such as a plasma display panel (“PDP”) and an organic light-emitting diode (“OLED”). In addition, the present invention can also be applied to a diffusion plate of an LCD with a direct-type light source module.

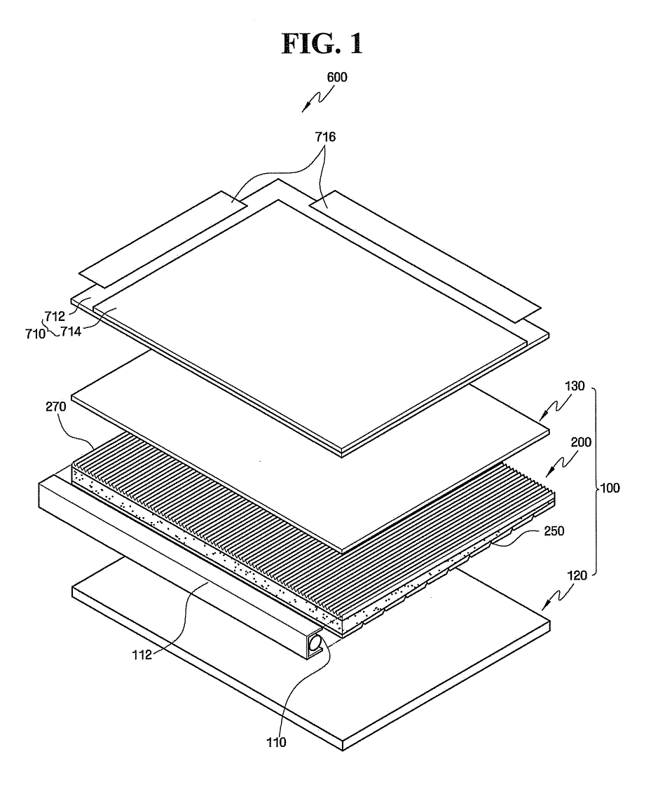

An exemplary embodiment of an LCD including an optical plate according to the present invention will hereinafter be described in detail with reference to FIG. 1. FIG. 1 illustrates an exploded perspective view of an exemplary embodiment of the LCD 600 including an optical plate according to the present invention.

Referring to FIG. 1, the LCD 600 includes a liquid crystal panel 710 displaying images, a driving circuit module 716 driving the liquid crystal panel 710, and a backlight assembly 100 providing light to the liquid crystal panel 710.

The liquid crystal panel 710 includes a first substrate 712, a second substrate 714 facing the first substrate 712, and a liquid crystal layer (not shown) interposed between the first substrate 712 and the second substrate 714.

The first substrate 712 may be a thin-film transistor (“TFT”) substrate on which a plurality of TFTs (not shown), which are switching devices, are formed as a matrix. A plurality of data lines (not shown) may be respectively connected to the source terminals of the TFTs, a plurality of gate lines (not shown) may be respectively connected to the gate terminals of the TFTs, and a plurality of pixel electrodes (not shown) may be respectively connected to the drain terminals of the TFTs.

The second substrate 714 may be a color filter substrate on which a plurality of Red, Green, Blue (“RGB”) pixels (not shown) for rendering colors are formed, such as in the form of thin films. A single or a plurality of common electrodes (not shown) may be formed of a transparent conductive material on the second substrate 714.

When power is applied to the gate terminals of the TFTs on the first substrate 712 and the TFTs are thereby turned on, an electric field is generated between the pixel electrodes and the common electrodes. Due to the electric field, the arrangement of liquid crystal molecules in the liquid crystal layer between the first substrate 712 and the second substrate 714 varies, thereby varying the transmittance of the liquid crystal layer. In this manner, the liquid crystal panel 710 displays images with a desired grayscale level.

The driving circuit module 716 includes a gate-driving unit (not shown) generating a plurality of gate signals and providing the gate signals to the respective gate lines, and a data-driving unit (not shown) generating an image data voltage and providing the image data voltage to the data lines.

The gate-driving unit and the data-driving unit may be connected to the liquid crystal panel 710 as a plurality of tape carrier packages (“TCPs”) or a chip on film (“COF”). Alternatively, the gate-driving unit and the data-driving unit may be directly mounted on the liquid crystal panel 710 as integrated circuits.

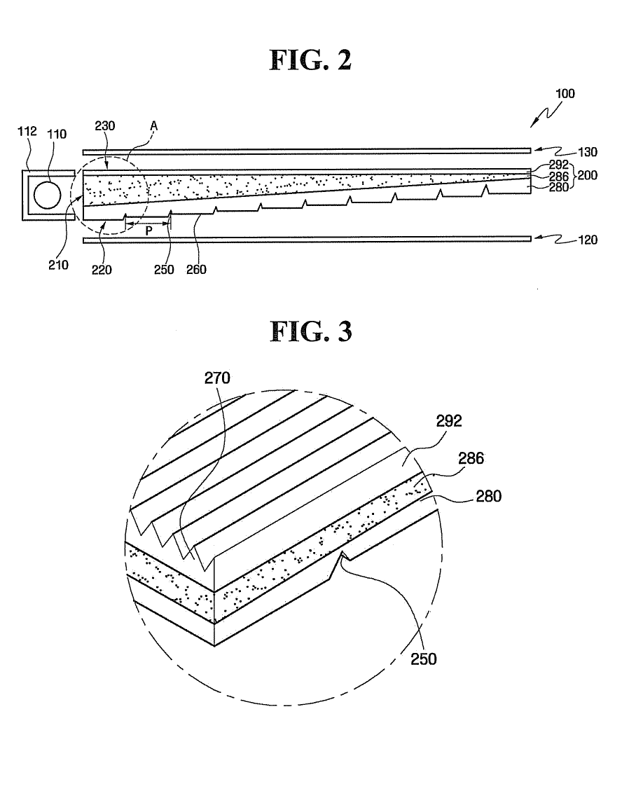

The backlight assembly 100 will hereinafter be described in further detail with reference to FIGS. 2 and 3. FIG. 2 illustrates a cross-sectional view of an exemplary embodiment of the backlight assembly of FIG. 1 according to the present invention, and FIG. 3 illustrates an enlarged perspective view of portion A of FIG. 2.

Referring to FIGS. 2 and 3, the backlight assembly 100 includes a light source 110, a light source cover 112 protecting the light source 110, a light guide plate 200 guiding light emitted from the light source 110, a reflective sheet 120 disposed below the light guide plate 200, and one or more optical sheets 130 disposed above the light guide plate 200.

In the illustrated embodiment, the light source 110 is disposed on one side of the light guide plate 200, however is not limited thereto. The light source 110 generates light in response to driving power applied thereto from an external source (not shown). In an exemplary embodiment, the light source 110 may be a cold cathode fluorescent lamp (“CCFL”), which may be formed as a thin cylinder. Alternatively, the light source 110 may be an external electrode fluorescent lamp (“EEFL”) having a pair of electrodes respectively disposed on both sides of the EEFL.

The light source cover 112 protects the light source 110 by surrounding the light source 110. The light source cover 112 may be disposed on all sides of the light source 100 except for portions facing an incident face of the light guide plate 200. The light source cover 112 not only protects the light source 110, but also may reflect light emitted from the light source 110 toward the light guide plate 200, thereby improving the efficiency of the use of light. In one exemplary embodiment, the light source cover 112 may include a reflective material to reflect the light from the light source 110 towards the incident face of the light guide plate 200.

The light guide plate 200 guides light emitted from the light source 110 and reflected by the light source cover 112. The light guide plate 200 may be formed of a transparent material in order to reduce light loss. In one exemplary embodiment, the light guide plate 200 may be formed of polymethylmethacrylate (“PMMA”) and/or may have a multilayered structure, such as will be described later in detail.

The light guide plate 200 includes a light incidence surface 210 upon which light emitted from the light source 110 is incident, a top surface 230 adjoining the light incidence surface 210, and a bottom surface 220 adjoining the light incidence surface 210 and faces the top surface 230. As in the illustrated embodiment, the light guide plate 200 may be formed substantially as a wedge, such that the thickness of the light guide plate 200 may become smaller as a distance from the light incidence surface 210 increases. Advantageously, even when the light source 110 is disposed on one side of the light guide plate 200, light emitted from the light source 110 easily reaches even a distant part (e.g., the distal end) of the bottom surface 220 of the light guide plate 200 from the light source 110 at the light incidence surface 210.

Referring to FIG. 2, the light guide plate 200 includes a core layer 286, an upper layer 292 disposed on the top surface of the core layer 286, and a lower layer 280 disposed on the bottom surface of the core layer 286. A plurality of upper prism patterns 270 are disposed on the upper layer 292. A plurality of lower prism patterns 250 and a plurality of flat (e.g., planar) areas 260 are disposed on the lower layer 280. As used herein, “upper” and “top” indicate a side of the light guide plate 200 towards a front or viewing side of the liquid crystal display 600, and “lower” and “bottom” indicate a side of the light guide plate 200 towards a rear of the liquid crystal display 600.

The upper prism patterns 270 may be formed as protrusions (e.g., extending outwardly from the core layer 286) or recesses (e.g., extending inwardly from an outer surface towards the core layer 286). The upper prism patterns 270 may occupy the entire upper layer 230, but are not limited thereto. The upper prism patterns 270 may be formed as stripes extending in a longitudinal direction and arranged in a direction transverse to the longitudinal direction, such as substantially perpendicular to the longitudinal direction and the light incidence surface 210. In the transverse direction, any of a number of the upper prism patterns 270 may be disposed directly adjacent to one another, or may be spaced apart from each other by a predetermined distance.

As in the illustrated embodiment, the upper prism patterns 270 may have a substantially triangular cross-section along a plane perpendicular to a direction in which the upper prism patterns 270 extend, as illustrated in FIG. 3. Alternatively, the upper prism patterns 270 may have a blunt top portion (e.g., apex), or, the upper prism patterns 270 may have a round top portion.

The lower prism patterns 250 may be formed as recesses. As in the illustrated embodiment, the lower prism patterns 250 may be formed as substantially triangular-shaped grooves, so as to vertically guide light incident upon the guide plate 200.

The lower prism patterns 250 may be formed as stripes that are separated from one another, and disposed (e.g., in an extended direction) substantially in parallel with the light incidence surface 210. As illustrated in FIGS. 2 and 3, the lower prism patterns 250 are extended in a first direction substantially in parallel with a longitudinal direction of the light source 110, whereas the upper prism patterns 270 are extended in a second direction substantially perpendicular to the light incidence surface 210. Thus, the upper prism patterns 270 are perpendicular to the lower prism patterns 250.

The lower prism patterns 250 may be substantially evenly spaced at intervals of a distance P. As illustrated in FIG. 2, a size of lower prism patterns 250 may become larger, as a distance from the light incidence surface 210 increases. The larger the prism patterns 250, the larger an overall area of the prism patterns 250 for receiving light, and the more light the prism patterns 250 emit toward the liquid crystal panel 710. A size of the prism patterns 250 may include a depth taken in a vertical direction from the bottom surface 220 of the lower layer 280 (e.g., perpendicular to a light exiting face of the light guide plate 200). The size may include a width taken in a horizontal direction at a widest part of the recess, such as at the bottom surface 220.

Advantageously, even though the light source 110 is disposed on one side of the light guide plate 200, and only a small amount of light emitted from the light source 110 may reach prism patterns 250 distant from the light source 110, it is possible to emit a uniform amount of light toward the liquid crystal panel 710, and thereby improve the uniformity of luminance for the liquid crystal display 600.

Referring to FIGS. 2 and 3, the flat areas 260 are disposed between the lower prism patterns 250, such that a flat area 260 alternates with a lower prism pattern 250. While one of the lower prism patterns 250 is disposed between the flat areas 260, the invention is not limited thereto. If the light guide plate 200 is formed as a wedge and the thickness of the light guide plate 200 becomes smaller as a distance from the light incidence surface 210 increases, the distance between the top surface 230 and the flat areas 260 may become smaller as the distance from the light incidence surface 210 increases. A distance between the flat areas 260 and a lower surface of the core layer 286 may be substantially the same across the lower surface. As in the illustrated embodiment, the flat areas 260 may be disposed substantially perpendicular to the light incidence surface 210, so as to meet the conditions for the total reflection of light guided by the light guide plate 200.

In alternative embodiments, the flat areas 260 may be inclined at an angle of about 0.1-0.3 degree to the top surface 230. The degree at which the flat areas 260 are inclined may also become larger as the distance from the light incidence surface 210 increases.

In an exemplary embodiment, if the flat areas 260 are downwardly inclined, the angle at which light is incident upon the flat areas 260 through the light incidence surface 210, and the angle at which light is reflected from the flat areas 260 may increase, thereby increasing the total reflectivity of the flat areas 260. In addition, the distance by which light travels after being reflected once may increase, and thus, the number of light reflections may decrease. Advantageously, it is possible to minimize light loss, increase valid light emitted from the top surface 230 and thus to improve luminance.

In the illustrated embodiment in FIGS. 2 and 3 of the light guide plate 200, light emitted from the light source 110 toward the light guide plate 200 is incident upon the light incidence surface 210, penetrates through the light guide plate 200 and is totally reflected by the flat areas 260. The angle of reflection of the total-reflected light is altered by the lower prism patterns 250 so that light is emitted toward the top (e.g., emitting) surface 230 of the light guide plate 200. Then, the light emitted toward the top surface 230 is collected (e.g., horizontally) by the upper prism patterns 270 on the top surface 230.

In an exemplary embodiment, the core layer 286 may be formed of a polymer material having a different glass transition temperature from that of the upper layer 292 and/or the lower layer 280.

The glass transition temperature of a polymer material will hereinafter be described in detail. A polymer generally has both a crystalline structure and an amorphous structure. The glass transition temperature of a polymer indicates the temperature at which an amorphous structure in the polymer melts, and different polymers have different glass transition temperatures. If a polymer is exposed to a temperature higher than its glass transition temperature, an amorphous structure in the polymer melts, and, thus, the polymer may become softer than is original state.

The polymer material of the core layer 286 may have a different glass transition temperature from that of the polymer material of the upper and lower layers 292 and 280. The core layer 286, and the upper and/or lower layers 292 and 280 may be formed of various polymer materials.

In one exemplary embodiment, the core layer 286 may be formed of PMMA, and the upper and lower layers 292 and 280 may be formed of polystyrene (“PS”).

PMMA has a transmittance of about 85% and provides excellent optical properties. PMMA is a weatherproof and relatively rigid material. PMMA is relatively easy to color and process and is thus able to form various shapes. The glass transition temperature of PMMA is about 110° C.

PS is a copolymer of liquid styrene monomer obtained by the reaction of ethylene and benzene. PS has a high refractive index and provides excellent optical properties. PS, which is one of the most relatively easy-to-process plastic materials, is transparent and is rigid once being plasticized. The glass transition temperature of PS is about 100° C.

Alternatively, the core layer 286 may include PMMA, and the upper and lower layers 292 and 280 may include a PS-methylmethacrylate (“MMA”) copolymer. PS-MMA copolymer has a property between a property of the PS and a property of the PMMA.

The upper and lower layers 292 and 280 may include a polymer material that is obtained by polymerizing the same monomer as that of a polymer material of the core layer 286, and has a different molecular weight from that of the polymer material of the core layer 286.

In one exemplary embodiment, the core layer 286, the upper layer 292 and the lower layer 280 may all include PMMA, and the molecular weight of the PMMA of the core layer 286 may be greater than the molecular weight of the PMMA of the upper and/or lower layers 292 and 280.

The glass transition temperature of the core layer 286 may be lower than the glass transition temperature of the upper and lower layers 292 and 280. The glass transition temperature of the upper and lower layers 292 and 280 may be lower than the temperature at which patterning is performed on a bare light guide plate, whereas the glass transition temperature of the core layer 286 may be higher than the temperature at which patterning is performed on a bare light guide plate. The glass transition temperature of the upper layer 292 may be the same as the glass transition temperature of the lower layer 280.

Referring again to FIG. 1, the reflective sheet 120 may be disposed below and directly adjacent to the bottom surface 220 of the light guide plate 200. The reflective sheet 120 reflects light leaked from the bottom surface 220 of the light guide plate 200 back to the light guide plate 200. The reflective sheet 120 may include a material with a high light reflectance. In one exemplary embodiment, the reflective sheet 120 may include a white polyethyleneterephthalate (“PET”) material or a white polycarbonate (“PC”) material.

The optical sheets 130 may be disposed above the light guide plate 200 and directly adjacent to the top surface 230 of the light guide plate 20, and improve the luminance of light emitted from the light guide plate 200 and/or the external appearance of the light guide plate 200.

In an exemplary embodiment, the optical sheets 130 may include a diffusive sheet (not shown), but are not limited thereto. Since the diffusive sheet 130 may be hazy, the optical sheets 130 address the problems associated with the quality of the external appearance of the light guide plate 200 by preventing the formation of bright lines, dark lines, or dark corner areas due to the lower prism patterns 250 and/or the upper prism patterns 270. In one exemplary embodiment, the diffusive sheet 130 may have a haze of about 50-70%.

In an exemplary embodiment, the diffusive sheet 130 may also include a prism sheet (not shown) on which a plurality of sheet prism patterns (not shown) are formed relatively close to one another. The sheet prism patterns may be formed as stripes that extend in parallel with the upper prism patterns 270 disposed on the top surface 230 of the light guide plate 200.

Alternatively, the sheet prism patterns may be formed as stripes that extend perpendicularly to the upper prism patterns 270. Still alternatively, the optical sheets may include a plurality of prism sheets, such as a first prism sheet on which a plurality of sheet prism patterns are formed as stripes that extend in parallel with the upper prism patterns 270, and a second prism sheet on which a plurality of sheet prism patterns are formed as stripes that extend perpendicularly to the upper prism patterns 270.

The sheet prism patterns of the prism sheet may have a substantially triangular cross-section. The sheet prism patterns may have a vertical angle of about 80-150 degrees from a base surface of the prism sheet. Alternatively, the sheet prism patterns may have a blunt top portion (e.g. apex), or, the sheet prism patterns may have a round top portion.

In an exemplary embodiment, the optical sheets 130 may also include a protective sheet. The protective sheet may be disposed above the prism sheet, and may thus protect the prism sheet. In addition, the protective sheet may be firmly attached (e.g., directly contacting) a liquid crystal panel, and may thus improve the external appearance of the liquid crystal panel. In one exemplary embodiment, the protective sheet 134 may have a haze of about 70-90%.

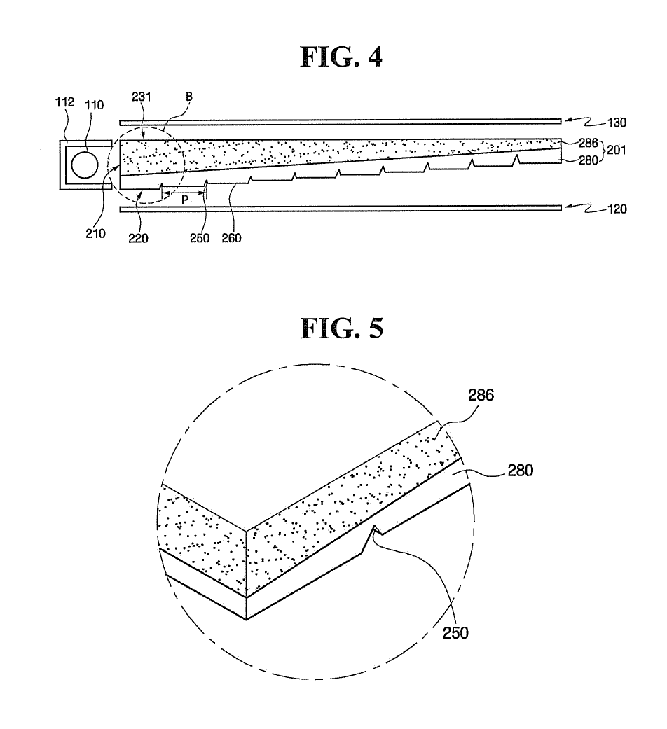

A backlight assembly 100 according to another embodiment of the present invention will hereinafter be described in detail with reference to FIGS. 1, 4 and 5. FIG. 4 illustrates a cross-sectional view of another exemplary embodiment of a backlight assembly according to the present invention, and FIG. 5 illustrates an enlarged perspective view of portion B of FIG. 4. In FIGS. 2 through 5, like reference numerals represent like elements, and thus, detailed descriptions thereof will be skipped.

Referring to FIGS. 1, 4 and 5, the backlight assembly 100 includes a light guide plate 201. The light guide plate 201 includes a light incidence surface 210 upon which light emitted from the light source 110 is incident, a top surface 231 which adjoins the light incidence surface 210, and a bottom surface 220 which adjoins the light incidence surface 210 and faces the top surface 230, a core layer 286 and a lower layer 280 disposed on a bottom surface of the core layer 286. The lower layer 280 includes a plurality of lower prism patterns 250 and a plurality of flat areas 260. The backlight assembly 100 of the embodiment of FIGS. 4 and 5, unlike the backlight assembly 100 of the embodiment of FIGS. 2 and 3, does not include an upper layer.

Alternatively, the backlight assembly 100 of the embodiment of FIGS. 4 and 5 may include, instead of the lower layer 280, only an upper layer disposed on the top of the core layer 286.

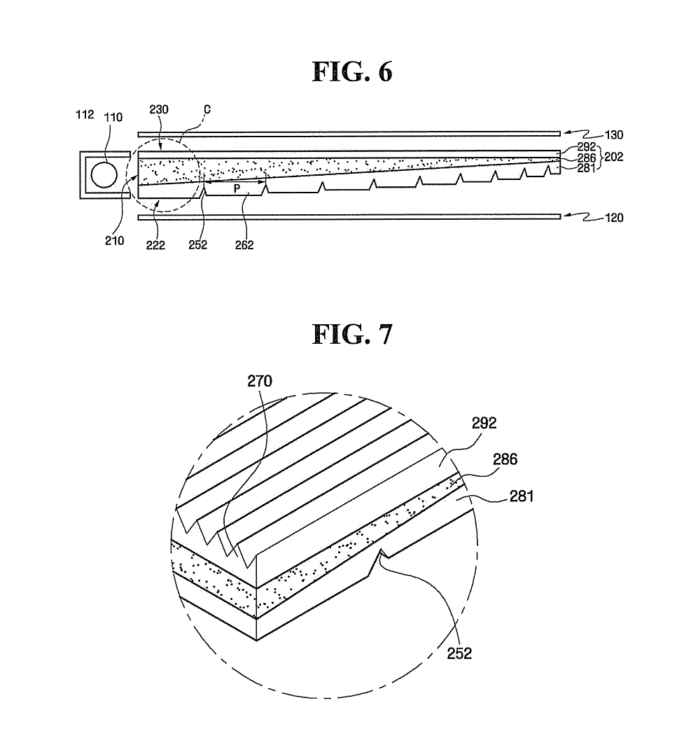

A backlight assembly 100 according to another embodiment of the present invention will hereinafter be described in detail with reference to FIGS. 1, 6 and 7. FIG. 6 illustrates a cross-sectional view of another exemplary embodiment of a backlight assembly according to the present invention, and FIG. 7 illustrates an enlarged perspective view of portion C of FIG. 6. In FIGS. 2, 3, 6 and 7, like reference numerals represent like elements, and, thus, detailed descriptions thereof will be skipped.

Referring to FIGS. 1, 6 and 7, the backlight assembly 100 includes a light guide plate 202. The light guide plate 202 includes a light incidence surface 210 upon which light emitted from the light source 110 is incident, a top surface 230 which adjoins the light incidence surface 210, and a bottom surface 222 which adjoins the light incidence surface 210 and faces the top surface 230, a core layer 286, an upper layer 292 disposed on the top surface of the core layer 286, and a lower layer 281 disposed on the bottom surface of the core layer 286. The upper layer 292 includes a plurality of upper prism patterns 270. The lower layer 281 may include a plurality of lower prism patterns 252 and a plurality of flat areas 262.

In the embodiment of FIGS. 6 and 7, unlike in the embodiment of FIGS. 2 and 3, the lower prism patterns 252 have a uniform size (e.g., depth and width). A distance between the flat areas 260 and a lower surface of the core layer 286 may be substantially constant. In order to improve the uniformity of luminance, a distance P between a pair of adjacent lower prism patterns 250 may become smaller as a distance from a light incidence surface 210 of the light guide plate 202 increases.

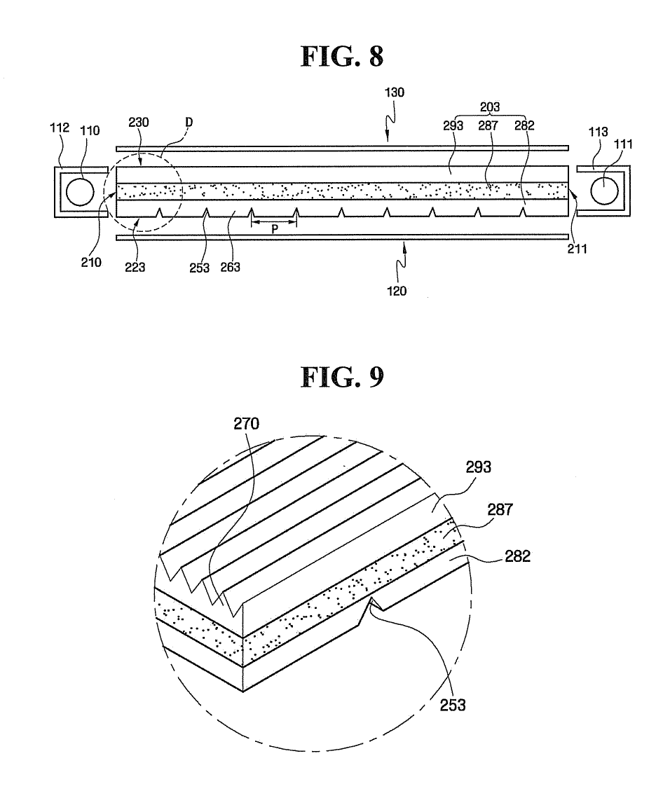

A backlight assembly 100 according to another embodiment of the present invention will hereinafter be described in detail with reference to FIGS. 1, 8 and 9. FIG. 8 illustrates a cross-sectional view of another exemplary embodiment of a backlight assembly according to the present invention, and FIG. 9 illustrates an enlarged perspective view of portion D of FIG. 8. In FIGS. 2, 3, 8 and 9, like reference numerals represent like elements, and thus, detailed descriptions thereof will be skipped.

Referring to FIGS. 1, 8 and 9, the backlight assembly 100 includes a plurality of light sources 110 and 111, a plurality of light source covers 112 and 113 covering the light sources 110 and 111, respectively, a light guide plate 203 guiding light emitted from the light sources 110 and 111, a reflective sheet 120 disposed below the light guide plate 203, and one or more optical sheets 130 disposed above the light guide plate 203.

The light sources 110 and 111 may be disposed on opposing sides of the light guide plate 203, relative to the light guide plate 203.

The light guide plate 203 includes light incidence surfaces 210 and 211 upon which light emitted from the light sources 110 and 111 is incident, a top surface 230 adjoining the light incidence surfaces 210 and 211, and a bottom surface 223 adjoining the light incidence surfaces 210 and 211 and facing the top surface 230. As in the illustrated embodiment, the light guide plate 203 may have a substantially uniform thickness.

The light guide plate 203 includes a core layer 287, an upper layer 293 disposed on the top surface of the core layer 287, and a lower layer 282 disposed on the bottom surface of the core layer 287. The upper layer 293 includes a plurality of upper prism patterns 270. The lower layer 282 includes a plurality of lower prism patterns 253 and a plurality of flat areas 263.

As in the illustrated embodiment, all of the lower prism patterns 253 disposed across the light guide plate 203 have a uniform size (e.g., depth and width). A distance between the bottom surface 223 and a lower surface of the core layer 287 are substantially constant. In order to improve the uniformity of luminance, a distance P between a pair of adjacent lower prism patterns 253 may be substantially equal to each other.

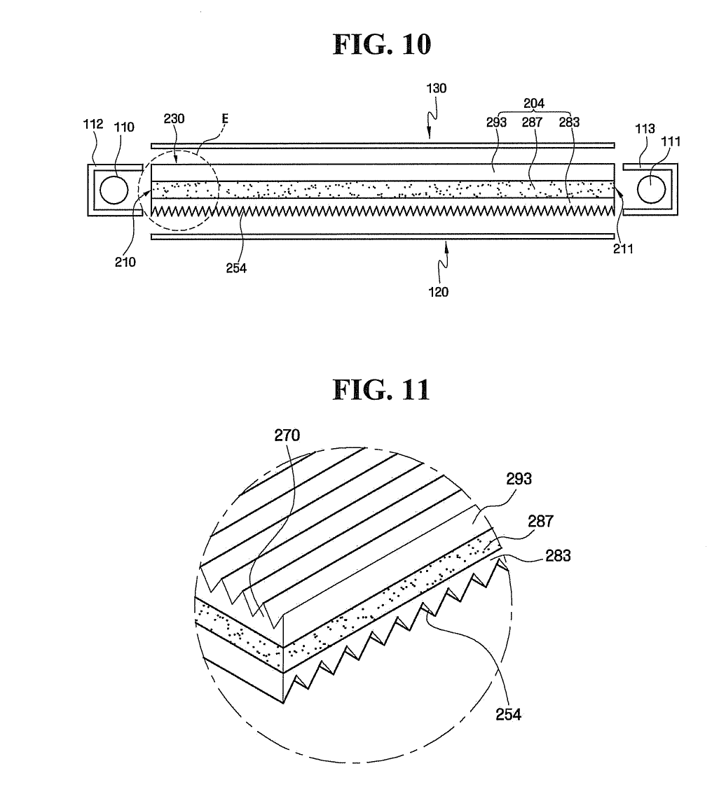

A backlight assembly 100 according to another embodiment of the present invention will hereinafter be described in detail with reference to FIGS. 1, 10 and 11. FIG. 10 illustrates a cross-sectional view of another exemplary embodiment of a backlight assembly according to the present invention, and FIG. 11 illustrates an enlarged perspective view of portion E of FIG. 10. In FIGS. 2, 3, 10 and 11, like reference numerals represent like elements, and thus, detailed descriptions thereof will be skipped.

Referring to FIGS. 1, 10 and 11, the backlight assembly 100 includes a light guide plate 204. The light guide plate 204 includes a core layer 287, an upper layer 293 disposed on the top surface of the core layer 287, and a lower layer 283 disposed on the bottom surface of the core layer 287. The upper layer 293 includes a plurality of upper prism patterns 270. The lower layer 283 includes a plurality of lower prism patterns 254. The lower layer 283, unlike the lower layer 253 illustrated in FIGS. 8 and 9, does not include flat areas.

The lower prism patterns 254 are disposed on a whole of a lower surface of the lower layer 283. The lower prism patterns 254 are disposed consecutively, since there are no flat areas disposed between lower prisms patterns 254. Lowest points of grooves or distal ends of protrusions of the lower prism patterns 254 are respectively disposed at a substantially a same distance from a lower surface of the core layer 287. A size of the lower prism patterns 254 are also substantially equal across an entire of the lower layer 253.

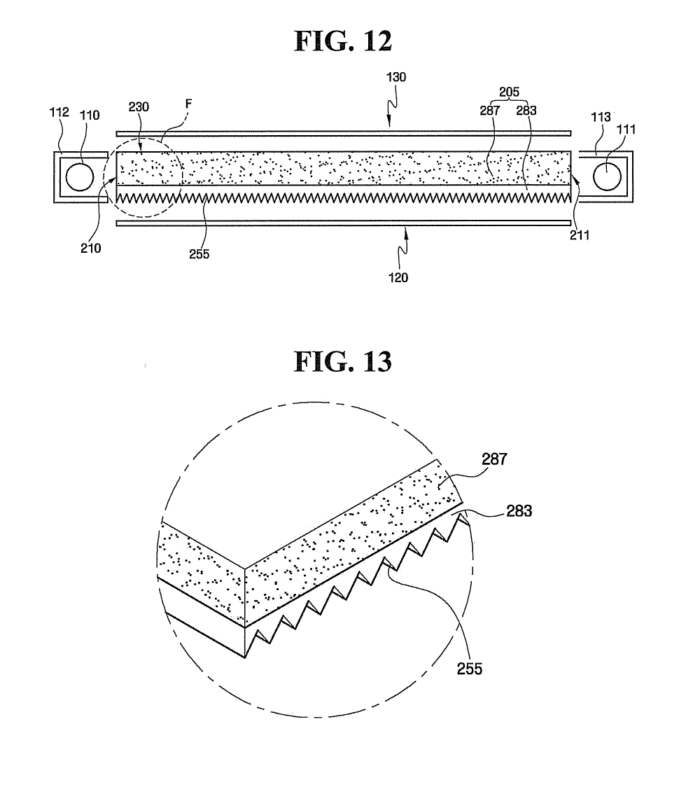

A backlight assembly 100 according to another embodiment of the present invention will hereinafter be described in detail with reference to FIGS. 1, 12 and 13. FIG. 12 illustrates a cross-sectional view of another exemplary embodiment of a backlight assembly according to the present invention, and FIG. 13 illustrates an enlarged perspective view of portion F of FIG. 12. In FIGS. 2, 3, 12 and 13, like reference numerals represent like elements, and, thus, detailed descriptions thereof will be skipped.

Referring to FIGS. 1, 12 and 13, the backlight assembly 100 includes a light guide plate 205. The light guide plate 205 includes a core layer 287 and a lower layer 283 disposed on the bottom surface of the core layer 287. The lower layer 283, unlike the lower layer 253 illustrated in FIGS. 8 and 9, does not include flat areas. The backlight assembly 100 of the embodiment of FIGS. 12 and 13, unlike the backlight assembly of the embodiment of FIGS. 8 and 9, does not include an upper layer.

Alternatively, the backlight assembly 100 of the embodiment of FIGS. 12 and 13 may include, instead of the lower layer 253, only an upper layer disposed on the top of the core layer 287.

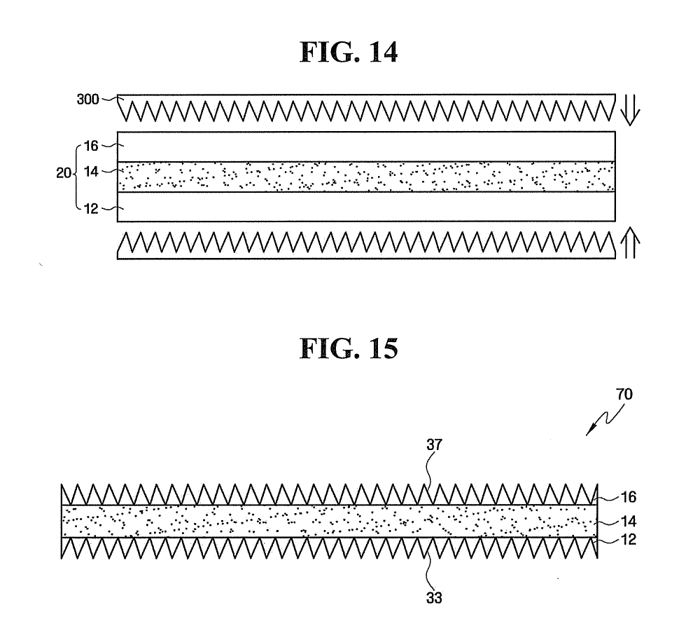

An exemplary embodiment of a method of manufacturing a light guide plate according to the present invention will hereinafter be described in detail with reference to FIGS. 14 and 15. FIG. 14 illustrates a cross-sectional view showing a method of patterning an initial (e.g., bare) light guide plate according to an embodiment of the present invention, and FIG. 15 illustrates a cross-sectional view of a light guide plate 70 obtained by the method of FIG. 14. In the illustrated embodiment of FIGS. 14 and 15, a bare light guide plate 20 includes a core layer 14, an upper layer 16 disposed on the top surface of the core layer 14 and including a plurality of upper prism patterns 37, and a lower layer 12 disposed on the bottom surface of the core layer 14 and including a plurality of lower prism patterns 33 extending substantially parallel with the upper prism patterns 37. The bare light guide plate 20 and the final light guide plate 70 is referred to as having a multilayer (e.g., a non single layer) structure, as including the upper layer 16, the core layer 14 and the lower layer 12. The bare light guide plate 20 does not include the prism patterns formed thereon.

Referring to FIGS. 14 and 15, the light guide plate 70 comprising prism patterns may be manufactured by firmly attaching a stamper mold 300 having patterns desired to be transferred to a bare light guide plate 20, and impressing the patterns desired to the lower and upper layers 12 and 16. The impressing may include performing a hot pressing method and/or a hydrostatic pressure method. In one exemplary embodiment, the hot pressing method includes transferring the patterns of a stamper using heat and pressure, and the hydrostatic pressure method includes transferring the patterns of a stamper by inducing a uniform distribution of pressure, such as by using water pressure.

If the bare light guide plate 20 has only a single layer structure, the bare light guide plate 20 may be deformed, such as due to heat and/or pressure applied thereto, during the formation of prism patterns. In order to address this, post-treatment such as cutting may be required, but disadvantageously, the manufacture of a light guide plate is complicated and increases the manufacturing cost of a light guide plate. In addition, due to such post-treatment, the edges of prism patterns on a light guide plate may become blunt, and, thus, the precision of dimension and/or profile of the light guide plate may deteriorate.

Referring to FIG. 14, the bare light guide plate 20, which has an initial multilayer structure, may be patterned by firmly attaching or contacting the stamper mold 300 to the bare light guide plate 20, and applying heat and/or pressure so that the patterns of the stamper mold 300 are transferred to the layers of the bare light guide plate 20.

In one exemplary embodiment, the bare light guide plate 20 may be manufactured by coextrusion. Coextrusion includes extruding more than one polymer material at substantially the same time. Since the properties of the polymer material of a core layer 14 of the bare light guide plate 20 may be similar to the properties of the polymer material of the upper and lower layers 16 and 12 of the bare light guide plate 20, the bare light guide plate 20 may be manufactured by coextrusion.

If the bare light guide plate 20 includes at least one of PMMA, PS and a PS-MMA copolymer, which are all relatively simple to process, it is also relatively easy to precisely form fine patterns on the bare light guide plate 20.

Alternatively, the bare light guide plate 20, which has a multilayer structure, may include a plurality of polymer materials having different glass transition temperatures. If prism patterns are formed only on the top or the bottom of the bare light guide plate 20, the bare light guide plate 20 may include the core layer 14 and either the upper layer 16 or the lower layer 12. If prism patterns are formed on both the top and the bottom of the bare light guide plate 20, the bare light guide plate 20 may include the core layer 14 and both the upper layer 16 and the lower layer 12.

In exemplary embodiments, the application of heat and/or pressure to the bare light guide plate 20 may be performed so that the bare light guide plate 20 reaches a temperature between the glass transition temperature of the core layer 14 and the glass transition temperature of the upper and lower layers 16 and 12.

During the transfer of the patterns of the stamper mold 300, the core layer 14 is exposed only to a temperature lower than its glass transition temperature and may thus maintain its rigidity, thereby reducing the probability of the core layer 14 being deformed. In contrast, during the transfer of the patterns of the stamper mold 300, the upper and lower layers 16 and 12 are exposed to a temperature higher than their glass transition temperature, become pliable or softer, and may thus facilitate the formation of fine prism patterns. Therefore, it is possible to transfer the patterns of the stamper mold 300 to the bare light guide plate 20 without extensive deformation of the bare light guide plate 20.

Since the glass transition temperature of the upper and lower layers 16 and 12 is lower than the glass transition temperature of the core layer 14, it is possible to transfer the patterns of the stamper mold 300 to the bare light guide plate 20 at a lower temperature than that required to transfer the patterns of the stamper mold 300 to a bare light guide plate having a single layer structure.

In an exemplary method of manufacturing a light guide plate, the thicknesses of the upper and lower layers 16 and 12 are respectively dependent upon the heights (e.g., depths) of upper prism patterns 37 and lower prism patterns 33. The thicknesses of the upper and lower layers 16 and 12 may be determined to be the same as the maximum height of prism patterns to be formed on the bare light guide plate 20. As a result, the upper or lower prism patterns 37 or 38 may include at least one valley that comes in contact with to the core layer 14 as illustrated in FIG. 15. Here, a valley is a portion formed by the slanting surfaces of a pair of adjacent upper or lower prism patterns 37 or 38.

If thicknesses of the upper and lower layers 16 and 12 are determined to be substantially the same as a maximum height of prism patterns to be formed on the bare light guide plate 20, the core layer 14 may account for most of the thickness of the bare light guide 20. That is, the upper and lower layers 16 and 12 are disposed at a minimum thickness to respectively achieve the upper and lower prism patterns 37 or 38. Here, an entire of the bare guide plate 20, except for the core layer 14, is deformed during the formation of the upper and lower prism patterns 37 and 38. Advantageously, it is possible to improve the stability of dimension of the resulting light guide plate 70 by reducing the deformation of the bare light guide plate 20 due to heat and/or external pressure during a manufacturing process. In addition, since the core layer 14 is stably maintained during the transfer of patterns to the bare light guide plate 20, it is possible for the light guide plate 70 to have the properties substantially that of the bare light guide plate 20.

Referring to FIGS. 14 and 15, the deformation of the bare light guide plate 20 due to heat and/or pressure applied during the formation of prism patterns is effectively prevented or reduced. Advantageously, it is possible to improve the stability of dimensions of the light guide plate 70, which is obtained by the patterning the bare light guide plate 20, without a requirement of post-treatment such as cutting. Furthermore, it is possible to facilitate the manufacture of the light guide plate 70, and to reduce the manufacturing cost of the light guide plate 70.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical plate comprising:
a core layer; and
a surface layer disposed on at least one surface of the core layer, and comprising a plurality of prism patterns,
wherein the core layer and the surface layer have different glass transition temperatures.

2. The optical plate of claim 1, wherein the glass transition temperature of the surface layer is lower than the glass transition temperature of the core layer.

3. The optical plate of claim 1, wherein the surface layer comprises an upper layer disposed on a top surface of the core layer, and a lower layer disposed on a bottom surface of the core layer, the upper layer and the lower layer having substantially the same glass transition temperature.

4. The optical plate of claim 1, wherein the prism patterns comprise at least one valley contacting the core layer.

5. The optical plate of claim 1, wherein the core layer and the surface layer comprise different polymer materials.

6. The optical plate of claim 5, wherein the core layer comprises polymethylmethacrylate (“PMMA”), and the surface layer comprises polystyrene (“PS”).

7. The optical plate of claim 5, wherein the core layer comprises PMMA and the surface layer comprises a PS-methylmethacrylate (“MMA”) copolymer.

8. The optical plate of claim 1, wherein the core layer and the surface layer comprise different polymer materials that are obtained by polymerizing the same monomer but have different molecular weights.

9. The optical plate of claim 8, wherein the core layer and the surface layer both comprise PMMA, and the molecular weight of the PMMA of the core layer is greater than the molecular weight of the PMMA of the surface layer.

10. A display device comprising:
a light source generating light;
an optical plate guiding light emitted from the light source, and comprising:
a core layer; and
a surface layer disposed on at least one surface of the core layer;
an optical sheet disposed on the optical plate; and
a display panel disposed on the optical sheet and displaying images,
wherein the surface layer of the optical plate comprises a plurality of prism patterns, and has a different glass transition temperature from that of the core layer.

11. The display device of claim 10, wherein the glass transition temperature of the surface layer is lower than the glass transition temperature of the core layer.

12. The display device of claim 10, wherein the surface layer comprises an upper layer disposed on a top surface of the core layer, and a lower layer disposed on a bottom surface of the core layer, the upper layer and the lower layer having substantially the same glass transition temperature.

13. A method of manufacturing an optical plate, the method comprising:
preparing a bare optical plate comprising a core layer and a surface layer disposed on at least one surface of the core layer, the surface layer having a different glass transition temperature from that of the core layer; and
forming a plurality of prism patterns on the surface layer.

14. The method of claim 13, wherein the preparing a bare optical plate comprises coextruding a material of the core layer and a material of the surface layer.

15. The method of claim 13, wherein the glass transition temperature of the surface layer is lower than the glass transition temperature of the core layer.

16. The method of claim 13, wherein the surface layer comprises an upper layer disposed on a top surface of the core layer, and a lower layer disposed on a bottom surface of the core layer, the upper layer and the lower layer having substantially the same glass transition temperature.

17. The method of claim 13, wherein the prism patterns comprise at least one valley contacting the core layer.

18. The method of claim 13, wherein the forming a plurality of prism patterns comprises impressing a stamper mold on the surface layer, and applying heat or pressure to the bare optical plate such that a temperature of the bare optical plate between the glass transition temperature of the core layer and the glass transition temperature of the surface layer is reached.
